(19) United States
(12) Patent Application Publication
(10) Pub. No.: US 2025/0248363 A1
(43) Pub. Date: Aug. 7, 2025

(54) MODULAR APPARATUS TO MEASURE RODENT SPATIAL AND SOCIAL COGNITION

(71) Applicant: BROWN UNIVERSITY, Providence, RI (US)

(72) Inventors: Taylor B. Wise, Providence, RI (US); Rebecca Burwell, Providence, RI (US)

(21) Appl. No.: 18/844,079

(22) PCT Filed: Mar. 17, 2023
(86) PCT No.: PCT/US2023/015485

§ 371 Date: Sep. 5, 2024

Related U.S. Application Data
(60) Provisional application No. 63/320,801, filed on Mar. 17, 2022.

(51) Int. Cl. A01K 1/03; A01K 29/00

(52) U.S. Cl. CPC A01K 1/031; A01K 29/005; A01K 2227/105

(57) ABSTRACT

An apparatus for measuring spatial and social cognition in rodents is provided. The apparatus can include a testing chamber extending in a horizontal plane and a plurality of stacked containment cages extending in the vertical plane underneath the testing chamber. The apparatus can also include an at least partially transparent testing chamber floor configured to separate the testing chamber and the plurality of stacked containment cages. A plurality of devices can be disposed or in communication with the testing chamber that are configured to measure spatial cognition, social cognition, or both. In certain aspects, the apparatus can include a plurality of testing chambers and a plurality of containment cages.

### CROSS-REFERENCE TO RELATED APPLICATIONS

The present application claims priority to U.S. Provisional Application No. 63/320,801, filed on Mar. 17, 2022, which is incorporated by reference in its entirety.

### GOVERNMENT FUNDING STATEMENT

This invention was made with government support under grant number R01 MH108729 awarded by the National Institutes of Health and grant number IOS-1656488 awarded by the National Science Foundation. The government has certain rights in the invention.

### TECHNICAL FIELD

The present application relates to a modular apparatus to measure spatial and social cognition in rodents.

### BACKGROUND

Throughout our evolution the ability to create, understand, and maintain social relationships has been crucial for survival. New evidence suggests that the same brain regions used for spatial cognition may be used for the representation of social networks. As an example, social relationships are often described on a continuum of “close” to “distant,” descriptors originally meant to depict positions in space. Neuroscientific research focused on specific mechanisms underlying spatial and social cognition rely on animal models, including rodents who are both excellent spatial navigators and highly social. Investigations of spatial and social cognition in rodents has been limited by apparatuses that are designed for studying only one of these cognitive domains. This hampers the use of rodents as a translational model for the study of the neural bases of human social and spatial cognition.

Nearly all prior apparatuses that incorporate spatial tasks are strictly horizontal in design, thereby restricting a rodent's inherent behavior to investigate what is underneath them. Further, in other apparatuses, there are no distinct subregions so rodents cannot be confined to any specific location. In addition, other apparatuses that incorporate spatial tasks measure a rat's ability to move through space as opposed to thinking about space. Similar limitations exist for apparatuses that incorporate social tasks, where most can only measure social interaction rather than cognitive ability. Critically, these tasks are difficult to modify to accommodate cognitive paradigms.

### SUMMARY

Apparatuses are provided that new approaches for using rodent models for studying spatial and social cognition. Such models can be used for research purposes directed to examining the characteristics of neural bases of social and spatial cognition. This includes investigations of the overlap in spatial and social cognition as well as broader applications for studying a rodent's ability to process spatial or social stimuli.

In an aspect, an apparatus for measuring spatial and social cognition in rodents comprises a testing chamber extending in a horizontal plane and a plurality of stacked containment cages extending in the vertical plane underneath the testing chamber. The apparatus can include an at least partially transparent testing chamber floor configured to separate the testing chamber and the plurality of stacked containment cages such that the plurality of stacked containment cages are visible but inaccessible from the testing chamber. A plurality of devices can be disposed or in communication with the testing chamber that are configured to measure spatial cognition, social cognition, or both. In certain aspects, the apparatus can include a plurality of distinct testing chambers and a plurality of containment cages.

In an aspect, an apparatus for measuring spatial and social cognition in rodents comprises a testing chamber extending in the horizontal plane and a plurality of stacked containment cages extending in the vertical plane underneath the testing chamber. At least one of the plurality of stacked containment cages defines an opening in a surface thereof. A ladder can be in communication with the opening allowing access from one containment cage to another containment cage. The apparatus can include an at least partially transparent testing chamber floor between the testing chamber and the plurality of stacked containment cage. A plurality of devices can be disposed in or in communication with the testing chamber configured to measure spatial cognition, social cognition, or both. In certain aspects, the apparatus can include a plurality of testing chambers and a plurality of containment cages.

### BRIEF DESCRIPTION OF DRAWINGS

FIG. 1 is a perspective view of an apparatus to measure rodent spatial and social cognition according to an aspect of the present disclosure.

FIG. 2 is a perspective view of an apparatus to measure rodent spatial and social cognition according to an aspect of the present disclosure.

FIG. 3 is a side view of containment cages of an apparatus to measure rodent spatial and social cognition according to an aspect of the present disclosure.

### DETAILED DESCRIPTION OF THE INVENTION

As used herein with respect to a described element, the terms “a,” “an,” and “the” include at least one or more of the described elements including combinations thereof unless otherwise indicated. Further, the terms “or” and “and” refer to “and/or” and combinations thereof unless otherwise indicated. By “substantially” is meant that the shape or configuration of the described element need not have the mathematically exact described shape or configuration of the described element but can have a shape or configuration that is recognizable by one skilled in the art as generally or approximately having the described shape or configuration of the described element.

Modular apparatuses for measuring rodent spatial and social cognition within one context are described herein. Such apparatuses allow rodents to explore a space that extends both horizontally and vertically; allow for control over visual, olfactory, and/or auditory experience of conspecifics in social tasks; permit design of parallel tasks that tap social and spatial cognition; permit examination of transfer of information across spatial and social domains; and allow rodents to discriminate across separate regions or confine them to others.

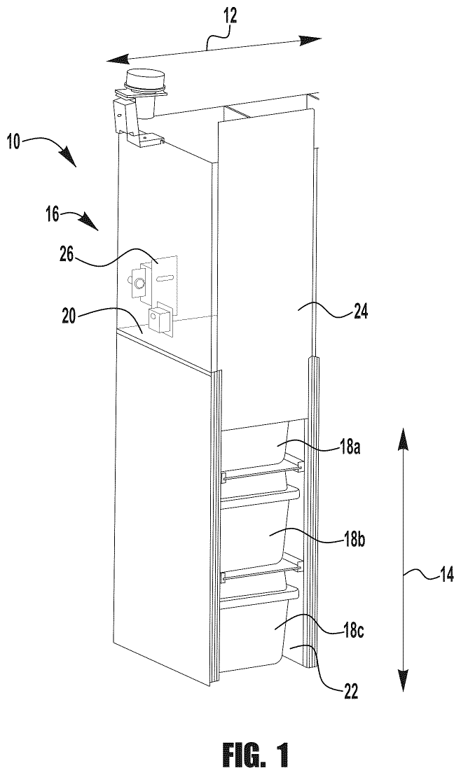

Referring to FIG. 1, in an aspect, an apparatus 10 for measuring spatial and social cognition in rodents is provided. Apparatus 10 has a horizontal plane 12 and a vertical plane 14. Apparatus 10 includes a testing chamber 16 extending in the horizontal plane 12 and a plurality of stacked containment cages 18 extending in the vertical plane 14 underneath testing chamber 16. In use, an observer rodent(s) can be placed in the testing chamber and a demonstrator rodent(s) can be placed in the containment cages. As depicted in FIG. 1, the containment cages are stacked such that they are arranged vertically. Although only three containment cages are illustrated in FIG. 1, the apparatus can contain any suitable number of containment cages. Further, a containment cage can be in contact with an adjacent containment cage or there can be a space between adjacent containment cages. The plurality of stacked containment cages 18 can be disposed in a housing 22 having a privacy door 24 attached to the outer surface thereof. In this aspect, the containment cages serve to confine a demonstrator rodent(s) at one vertical level such that the demonstrator rodent(s) remains at a designated spatial distance from the observer rodent(s). Apparatus 10 can also include an at least partially transparent testing chamber floor 20 configured to separate testing chamber 16 and the plurality of stacked containment cages such that the plurality of stacked containment cages are visible but inaccessible from the testing chamber. The testing chamber floor closes off the testing chamber from the containment cages, although the testing chamber floor can define apertures therethrough. In such an aspect, an observer rodent(s) in the testing chamber can see, smell, and/or hear the demonstrator rodent(s) in the containment cages but cannot physically access the demonstrator rodent(s). In testing, a demonstrator rodent(s) can be placed in a containment cage at each vertical level and the observer rodent(s) ability to observe the demonstrator rodent(s) from near, middle, far, or ego-centric distances can be tested. Testing chamber 16 can includes a plurality of devices 24 configured to measure spatial cognition, social cognition, or both. FIG. 1 illustrates a lever as the cognitive measurement device but other devices can be included as described below.

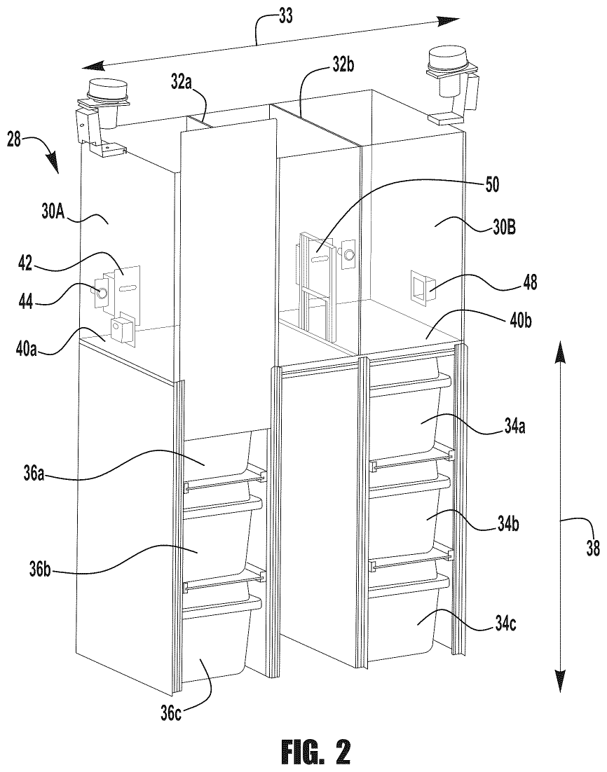

Referring to FIG. 2, in an aspect an apparatus 28 is provided that is similar to apparatus 10 but includes a plurality of distinct testing chambers that are inaccessible from one another. In particular, apparatus 28 includes a plurality of testing chambers 30 extending in the horizontal plane 33. Each of the plurality of testing chambers 30 is separated by at least one divider 32, which creates the distinct testing chambers. A plurality of stacked containment cages extending in the vertical plane 38 is underneath a respective one of the plurality of testing chambers 30.

For instance, containment cages 36a-36c are disposed underneath testing chamber 30A and containment cages 34a-34c are disposed underneath testing chamber 30B. Apparatus 28 also includes an at least partially transparent testing chamber floor configured to separate each of the plurality of testing chambers from the respective one of the plurality of stacked containment cages such that the plurality of stacked containment cages are visible but inaccessible from the respective one of the plurality of testing chambers. For instance, testing chamber floor 40a separates testing chamber 30A from containment cages 36a-36c and testing chamber floor 40b separates testing chamber 30B from containment cages 34a-34c. A plurality of devices are disposed in each of the plurality of testing chambers configured to measure spatial cognition, social cognition or both. Such devices can include an automated lever 42, a light 44, a reward dispenser such as a pellet dispenser 46 and pellet receptacle 48, a guillotine door 50, an interchangeable floor, or combinations thereof. The apparatus could include any suitable number of the same or different devices to measure spatial and/or social cognition and the above-mentioned devices are only exemplary.

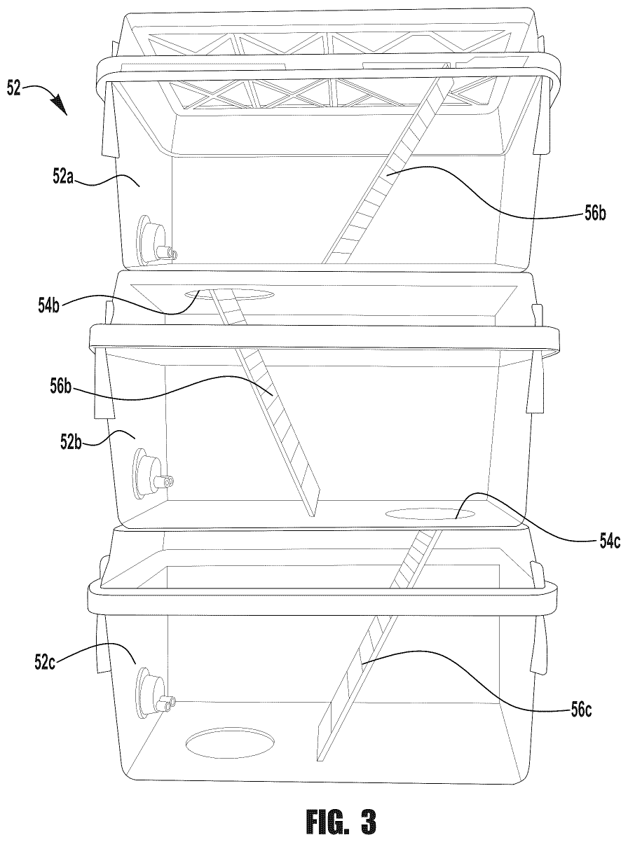

Although in FIGS. 1 and 2, the plurality of containment cages are inaccessible from one another such that a demonstrator(s) rodent is confined to a specific vertical level, in certain aspects the apparatus can be configured to allow rats to explore space in the vertical and/or horizontal direction. For instance, FIG. 3 depicts at least one of the plurality of containment cages 52 (such as cages 52b and 52c) defining an respective opening 54b and 54c in a surface thereof. A ladder 56 can be in communication with the opening 54 allowing access from one containment cage to another containment cage. In certain aspects, the at least partially transparent testing chamber floor or the top most containment cage can define an opening in communication with a ladder (e.g. ladder 56a) so that the observer rodent(s) can explore the entire apparatus.

### Exemplary Protocol

### Subjects

N=8
Pair housed

### Habituation

Each habituation will last 10 min per rat. Food will be sprinkled through maze to encourage exploration.
1. Test room—subjects remain in homecages for 10 min, then handled 5 min each (2 days)
2. Maze platform—placed in center chamber. Can explore all west, center, and east (2 days)
3. Demonstrator—demonstrator rats habituate to their holding cage 10 min in west/east column (2 days)

### Vertical Exploration

1. Maze all levels—cagemates placed together in bottom level and allowed to explore all levels of one column via stacked cages and can access West or east chamber platform for 30 min/day.
   a. Can explore 2 days (1 day per chamber side). Will be repeated so rats explore all levels of each west or east individually.
   b. Doors in chambers will remain closed so that rats must map vertical space only.
   c. Aluminum floor with hole (covered) used
   d. Food sprinkled throughout
   e. Experimenter will record if each rat explored all three levels and testing platform. If any rat does not explore all levels, repeat this the next day (1-2 days).
2. Levels refresher—if considerable time has elapsed between habituation and testing, rats will repeat “Maze all levels” habituation until each cagemate explores all three levels.

### Phase 1—Sociability

Sociability lasts 10 min per rat with one demonstrator present on the west/east side. Main measures will include duration of time spent in each chamber.
1. Prior to testing, Demonstrator 1 will be placed in the west/east side
   a. If using the Vertical Maze, demonstrators will be held inside a holding cage that includes bedding, nesting, and food.
      i. Dem cage will be placed at the appropriate vertical level.
2. Place rat in center chamber and open guillotine doors for access to west/east chambers
3. At end of 10 min, place rat back in closed center chamber for 2 min ITI
   a. Prep Dem 2 for next phase

### Phase 2—Social Novelty

Social Novelty Lasts 10 Min Per Rat with Two Demonstrators, One on Each Side. Main Measures Remain Constant.
1. During 2 min ITI, place Demonstrator 2 in appropriate west/east side
   a. If in Vertical Maze, follow all demonstrator prep from above
   b. Replenish food for Dem 1
2. After ITI, raise guillotine doors to being Phase 2
3. At the end of 10 min, place rat and demonstrators back in homecages
   a. Demonstrators will be given 20+ min of break between trials where they can rest in their homecage

### Example 1

Prior to any testing, subject rats were habituated to the apparatus and were allowed to explore the vertical columns of the maze (see Habituation and Vertical Exploration in the above-referenced protocol). One control group received general habituation to the upper testing platform, but were not allowed to explore vertical columns prior to test.

Using a modified protocol to the 3-Chamber task, subjects were then placed in the top half of the maze (testing platform). In this portion of the maze, subject rats could explore the West, Center, and East chamber, and perceive conspecifics placed underneath them through a grated floor. Conspecifics were confined to holding cages at a specific spatial distance within each vertical column. All possible spatial distances were used. Subject rat's exploration of the West and East chambers was recorded.

### Subjects—24 TOTAL

Control (n=8)
Near Vertical Distance (n=8)
Middle Vertical Distance (n=8)
Far Vertical Distance (n=8)

### Phase 1—Sociability

In the Sociability phase, subject rats were placed in the center chamber and allowed to explore either side chamber. On one side, a holding cage containing one novel demonstrator rat was placed in the vertical column. The other vertical column remained empty. This measured rat's preference for a social vs. non-social context.

### Phase 2—Social Novelty

In the social novelty phase, subject rats were again placed in the center chamber and allowed to explore all chambers. On one side, the demonstrator from Phase 1 remained in position. This demonstrator was now considered familiar to the subject. On the opposite side, a new demonstrator was now placed within the vertical column and was entirely novel to the subject. Both demonstrators were placed at the same vertical distance. This phase measured rat's preference for familiar vs. novel social contexts.

### Results

Exploration results for each chamber were transformed into a Discrimination Ratio (DR).

$$Phase 1 — Sociability :$$

$$D R = \frac{Social Context Exploration - NonSocial Context Exploration}{Total Exploration}$$

DR of +1 indicates preference for the social context; DR of 0 indicates no preference.

$$Phase 2 — Social Novelty :$$

$$D R = \frac{\begin{matrix}Novel Social Context Exploration - \\ Familiar Social Context Exploration\end{matrix}}{Total Exploration}$$

DR of +1 indicates preference for social novelty; DR of 0 indicates no preference.

First, we compared groups that received vertical exploration prior to training vs control rats. Given that rats not only map space horizontally, but also vertically, we predicted that vertical exploration of the maze would be crucial for subjects to perceive demonstrators underneath them. We found that subjects that previously received vertical exploration replicated expected social preference behavior for both phases of the 3Chamber task. In Phase 1, these animals preferred the social context compared to the non-social context; in Phase 2, they preferred social novelty. This is consistent with prior findings in the standard 3-chamber apparatus. Interestingly, control animals that did not receive prior vertical exploration showed no preference in Phase 1, suggesting that without a previous mapping of vertical space they did not perceive any demonstrator rat underneath. Control animals also showed a reverse preference in Phase 2, possibly showing that they eventually became aware of conspecifics underneath the, but at a much slow rate.

Second, we compared DR results for subjects that perceived demonstrator at the near, middle, and far spatial distances for both phases.

We found that subjects replicated prior sociability and social novelty preferences for all possible vertical distances. Regardless of whether demonstrators were placed at the near, middle, or far distances, subject rats preferred the social context in Phase 1, and the social novelty context in Phase 2.

Previous data shared with Brown Technology Innovations showed that in a separate cohort of subjects (n=8), rats were capable of recognizing a demonstrator at each vertical distance, and is supported by this new data. Critically, in those prior analyses, we also found a statistical interaction between distance and exploration time of the social context—this means that rats not only know a demonstrator is present, but also can distinguish between whether said demonstrator is in the near, middle, or far distance.

### CONCLUSIONS

Thus far, our technology has proven to be an effective method for measure rat's spontaneous social exploration, while providing a novel spatial component. Emerging lines of research are growing more interested in spatial mapping of the vertical plane, and could benefit from an apparatus like the Vertical Maze. In these results, we found that rats replicate natural social behaviors commonly seen in social paradigms standard to the field, and this is true at all vertical distances.

While this work has focused on our technology's ability to capture spontaneous exploration, the Vertical Maze is also capable of measuring more complex decision making processes. This is accomplished through our inclusion of automated levers, lights, speakers, doors, and pellet dispensers. Currently, our research is collecting data on how we can best capture rat's decision making abilities in the Vertical Maze, including testing their knowledge of vertical space and well as social identity of conspecifics. There is a growing interest in the use of rats for studying complex decision making, and researchers could utilize our spatial-social apparatus for testing these cognitive processes.

Each of the disclosed aspects and embodiments of the present disclosure may be considered individually or in combination with other aspects, embodiments, and variations of the disclosure. Further, while certain features of embodiments and aspects of the present disclosure may be shown in only certain figures or otherwise described in the certain parts of the disclosure, such features can be incorporated into other embodiments and aspects shown in other figures or other parts of the disclosure. Along the same lines, certain features of embodiments and aspects of the present disclosure that are shown in certain figures or otherwise described in certain parts of the disclosure can be optional or deleted from such embodiments and aspects. Additionally, when describing a range, all points within that range are included in this disclosure. Further, unless otherwise specified, none of the steps of the methods of the present disclosure are confined to any particular order of performance. Furthermore, all references cited herein are incorporated by reference in their entirety.

What is claimed is:

1. An apparatus for measuring spatial and social cognition in rodents, the apparatus having a horizontal plane and a vertical plane and comprising:
a testing chamber extending in the horizontal plane;
a plurality of stacked containment cages extending in the vertical plane underneath the testing chamber;
an at least partially transparent testing chamber floor configured to separate the testing chamber and the plurality of stacked containment cages such that the plurality of stacked containment cages are visible but inaccessible from the testing chamber; and
a plurality of devices disposed or in communication with the testing chamber configured to measure spatial cognition, social cognition, or both.

2. The apparatus of claim 1, wherein the plurality of devices includes an automated lever, a light, a reward dispenser, a guillotine door, an interchangeable floor, or combinations thereof.

3. The apparatus of claim 1, wherein the plurality of stacked containment cages are inaccessible from one another.

4. The apparatus of claim 1, wherein the plurality of stacked containment cages are disposed in a housing, the housing having a privacy door attached to the outer surface thereof.

5. An apparatus for measuring spatial and social cognition in rodents, the apparatus having a horizontal plane and a vertical plane and comprising:
a plurality of testing chambers extending in the horizontal plane;
one or more dividers separating the plurality of testing chambers into distinct testing chambers;
a plurality of stacked containment cages extending in the vertical plane underneath a respective one of the plurality of testing chambers;
an at least partially transparent testing chamber floor configured to separate each of the plurality of testing chambers from the respective one of the plurality of stacked containment cages such that the plurality of stacked containment cages are visible but inaccessible from the respective one of the plurality of testing chambers; and
a plurality of devices disposed in or in communication with each of the plurality of testing chambers configured to measure spatial cognition, social cognition or both.

6. The apparatus of claim 5, wherein the plurality of devices includes an automated lever, a light, a reward dispenser, a guillotine door, an interchangeable floor, or combinations thereof.

7. The apparatus of claim 5, wherein the plurality of stacked containment cages are inaccessible from one another.

8. The apparatus of claim 5, wherein each of the plurality of stacked containment cages are disposed in a housing, the housing having a privacy door attached to the outer surface thereof.

9. An apparatus for measuring spatial and social cognition in rodents, the apparatus having a horizontal plane and a vertical plane and comprising:
a testing chamber extending in the horizontal plane;
a plurality of stacked containment cages extending in the vertical plane underneath the testing chamber, at least one of the plurality of stacked containment cages defining an opening in a surface thereof;
a ladder in communication with the opening allowing access from one containment cage to another containment cage;
an at least partially transparent testing chamber floor between the testing chamber and the plurality of stacked containment cage; and
a plurality of devices disposed in or in communication with the testing chamber configured to measure spatial cognition, social cognition, or both.

10. The apparatus of claim 9, wherein the at least partially transparent testing chamber floor or the top most containment cage defines an opening in a surface thereof.

11. The apparatus of claim 10, further comprising a ladder in communication with the opening.

12. The apparatus of claim 9, wherein the plurality of devices includes an automated lever, a light, a reward dispenser, a guillotine door, an interchangeable floor, or combinations thereof.

13. The apparatus of claim 9, wherein the plurality of stacked containment cages are disposed in a housing, the housing having a privacy door attached to the outer surface thereof.

14. An apparatus for measuring spatial and social cognition in rodents, the apparatus having a horizontal plane and a vertical plane and comprising:
a plurality of testing chambers extending in the horizontal plane;
one or more dividers separating the plurality of testing chambers into distinct testing chambers;
a plurality of stacked containment cages extending in the vertical plane underneath a respective one of the plurality of testing chambers, at least one of the plurality of stacked containment cages defining an opening in a surface thereof;
a ladder in communication with the opening allowing access from one containment cage to another containment cage;
an at least partially transparent testing chamber floor between each of the plurality of testing chambers and the respective plurality of stacked containment cages; and
a plurality of devices disposed in or in communication with at least one of the plurality of testing chambers configured to measure spatial cognition, social cognition or both.

15. The apparatus of claim 14, wherein the at least partially transparent testing chamber floor or the top most containment cage defines an opening in a surface thereof.

16. The apparatus of claim 15, further comprising a ladder in communication with the opening.

17. The apparatus of claim 14, wherein the plurality of devices includes an automated lever, a light, a reward dispenser, a guillotine door, an interchangeable floor, or combinations thereof.

18. The apparatus of claim 1, wherein each of the plurality of stacked containment cages are disposed in a housing, the housing having a privacy door attached to the outer surface thereof.
